(19) United States
(12) Patent Application Publication
(10) Pub. No.: US 2017/0020198 A1
(43) Pub. Date: Jan. 26, 2017

(54) E-cigarette actuator

(71) Applicant: MSP Corporation, Shoreview, MN (US)

(72) Inventors: Amir Naqwi, Eden Prairie, MN (US); Benjamin Y.H. Liu, North Oaks, MN (US)

(21) Appl. No.: 15/217,309

(22) Filed: Jul. 22, 2016

Related U.S. Application Data
(60) Provisional application No. 62/195,520, filed on Jul. 22, 2015.

(51) Int. Cl. A24F 47/00; G01M 99/00

(52) U.S. Cl. CPC A24F 47/008; G01M 99/008

(57) ABSTRACT

A device having a cavity configured to receive or to hold an e-cigarette, which includes a push-hold button to actuate vapor generation and/or formation. The device further comprises an automatic plunger capable of pressing the push-hold button based upon a command. The plunger may receive the command from a controller or alternatively from the airflow caused by the puff. A mechanism configured for positioning the automatic plunger proximate to the push-hold button is also incorporated into the device.

### CROSS-REFERENCE TO RELATED APPLICATION

This application is based on and claims the benefit of U.S. provisional patent application Ser. No. 62/195,520, filed Jul. 22, 2015, the content of which is hereby incorporated by reference in its entirety.

### BACKGROUND

E-cigarettes first appeared in the U.S. around 2007. Since then, e-cigarettes have become increasingly popular. It is estimated that up to 10% of U.S. high school students have tried them at least once in 2012 and up to 3.4% of U.S. adults have used e-cigarettes. In order to study the health effect or potential health effect due to the use of the e-cigarettes, it is usually necessary to generate a smoke for analysis.

Older versions of e-cigarettes are breath-actuated. However, newer and more popular ‘tank-type’ e-cigarettes have push-hold button to power a heating element that vaporizes the nicotine-containing liquid. In order to test such e-cigarettes with the existing smoking machines, there is a need for an e-cigarette holder that would include a sensor to sense the existence of a puff Based on the signal from the sensor, an automatic plunger will press the push-hold button, keeping the e-cigarette's heating element powered for the duration of the puff

### SUMMARY

The present disclosure relates to an actuator system. The actuator system is configured for use with a device for generating vapor. In one embodiment, the actuator system may be used with or incorporated into an e-cigarette device, or similar vaporization type devices. The actuator system may be used with a device comprising a housing and a cavity configured to receive or to hold an e-cigarette, which includes a push-hold button to actuate vapor generation. The actuator system comprises an automatic plunger capable of pressing the push-hold button based upon a command. The command may be indicative of air flow and thus the automatic plunger movement is controlled by the presence of air circulation or lack thereof Thus, the actuator system of the present disclosure is configured such that the push-hold button may be pushed and held during the duration of air circulation in the device or housing and thus during the duration of a puff. The plunger may receive the command from a controller or alternatively automatically from the puff itself, and the command may be either manually selected or automatic and based on an air circulation or flow. A mechanism configured for positioning the automatic plunger proximate to the push-hold button may also be incorporated into the actuator system.

The actuator system may also further include a sensor configured to sense the movement of air within the device and to generate a signal indicative of air movement. The sensor may be in communication with a controller configured to receive the signal from the sensor. The device then further comprises the controller configured to actuate the automatic plunger to press the push-hold button upon receiving said signal.

The plunger is configured for reciprocal movement wherein the plunger can be displaced a distance in the range of approximately 0.2 mm to approximately 10 mm The device may further include a mechanism configured to receive and utilize an external signal to actuate the plunger.

### BRIEF DESCRIPTION OF THE DRAWINGS

FIG. 1 is a schematic view of an e-cigarette actuator.

FIG. 2 is a flow chart illustrating using the device with an automatic sensor.

FIG. 3 is flow chart illustrating using the device with a controller.

### DETAILED DESCRIPTION

Older versions of e-cigarettes are breath-actuated. However, newer and more popular ‘tank-type’ e-cigarettes have a push-hold button to power a heating element that vaporizes the nicotine-containing liquid. In order to test such e-cigarettes with the existing smoking machines, there is a need for an e-cigarette holder that would include a sensor to sense the existence of a puff. Based on the signal from the sensor, an automatic plunger can press the push-hold button, keeping the e-cigarette's heating element powered for the duration of the puff.

An e-cigarette actuator, or actuator system, according to embodiments of this disclosure should have enough flexibility to accommodate various e-cigarette formats from multiple vendors. It is understood that the smoking machines are mature products with features needed for collecting cigarette smoke for a number of puff topographies. Researchers are interested in using these puff topographies with e-cigarettes. Since e-cigarettes need to be actuated, researchers are currently using manual actuation and trying to keep the actuation synchronized with the breathing pattern of the smoking machine. This procedure is labor intensive and unreliable. Hence, there is a need for an automated actuator. The automated actuator of the present disclosure is configured to maintain vapor production during the length (time) of a puff.

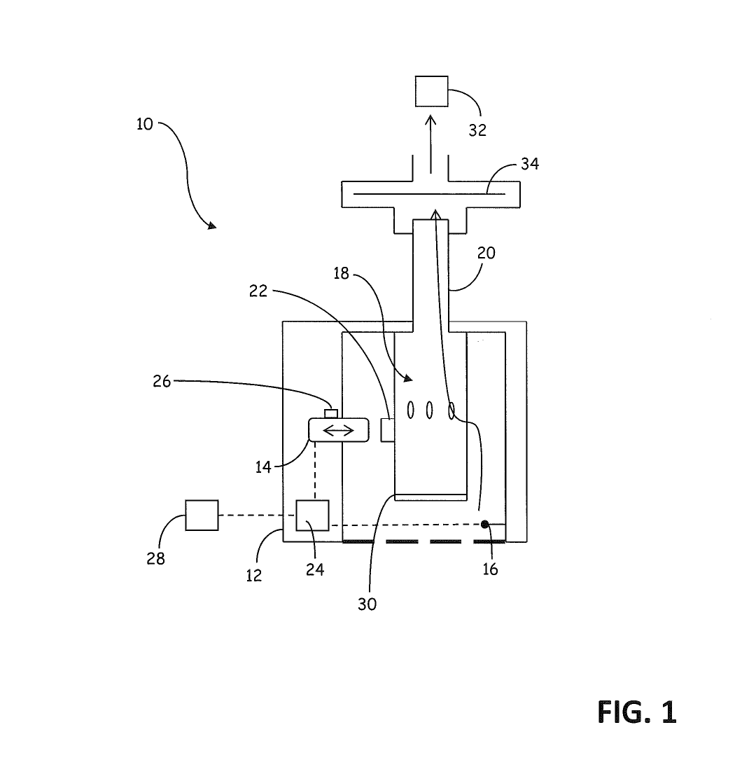

As illustrated generally in FIG. 1, the actuator system 10 may be configured for use with a vaporizing device, such as e-cigarette device. The system 10 is used with a housing 12 configured to receive and hold an e-cigarette 20 and to generate a vapor for inhaling or puffing. The actuator system 10 which comprises a plunger 14 and a sensor 16. t The housing 12 may be an e-cigarette device where the actuator system and thus plunger 14 and sensor 16 are incorporated and positioned therein. The actuator system 10 may also be used or similarly incorporated into in similar other vaporization type devices. The housing 12 generally comprises an opening or cavity 18 configured to receive the e-cigarette 20 therein. The actuator 22 is a part of the e-cigarette 20 and may be a switch or as illustrated in FIG. 1, actuator 22 is a push-hold button 22 configured to actuate a heating element 30 for vapor generation and/or vapor formation from the e-cigarette. Actuation of the heating element allows for the vaporization of a liquid in the e-cigarette, for example, a nicotine-containing liquid. The system 10 is capable of sensing the existence of a “puff” on the e-cigarette based on the detection of air circulation, movement or flow in and/or through the housing 12. Based on this signal, which is transmitted from the sensor via a controller to the automatic plunger 14, the signal allows for the actuation of the plunger 14 corresponding to the duration of the puff.

The plunger 14 may be an automatic plunger 14 capable of contacting and depressing the push-hold button 22 on command. The plunger 14 may then be in communication with a control element 24 such that the plunger 14 may be configured to receive a command from the controller 24. Thus, actuation of the plunger 14 may comprise moving the plunger via a movement mechanism 26 operably connected to the plunger 14 and in communication with the controller 24 which controls movement of the plunger 14. The plunger 14 thus contacts and presses/holds the push-hold button 22 for keeping the heating element active for the duration of the puff.

The mechanism 26 configured for positioning the automatic plunger 14 proximate to the push-hold button 22 for keeping the push-hold button 22 depressed or (pushed and held in place for vaporization) may also be incorporated into the housing 12. The plunger 14 is thus also configured for reciprocal movement such that the plunger 14 can be displaced a distance in the range of approximately 0.2 mm to approximately 10 mm, for example, linearly in order to push and hold the button 22 and is also moveable in reciprocating directions to actuate the push-hold button 22 and to deactivate the push-hold button and thus controlling operation of the heating element 30.

The sensor 16 is configured to detect the movement of air within the device 10 and to generate a signal indicative of air movement, which may be a puff or movement of the vapor generated. The sensor is in communication with controller 24 such that the sensor may generate a signal for transmission to the controller 24 for actuating the automatic plunger 14 to press the push-hold button 22 upon receipt of said signal.

The device 10 may further include a mechanism 28 configured to receive and utilize an external signal, whether manual or automatic, to actuate the plunger 14. The external signal may eliminate the need for the sensor 16 within the device 10. The actuator can also be used without the internal sensor 16 such that is can be removed from the device 10. The actuator may then be operably controlled by an external signal generated by mechanism 28 to actuate the plunger 14. Such an external signal may originate from a computer program 28 or from a smoking machine 32.

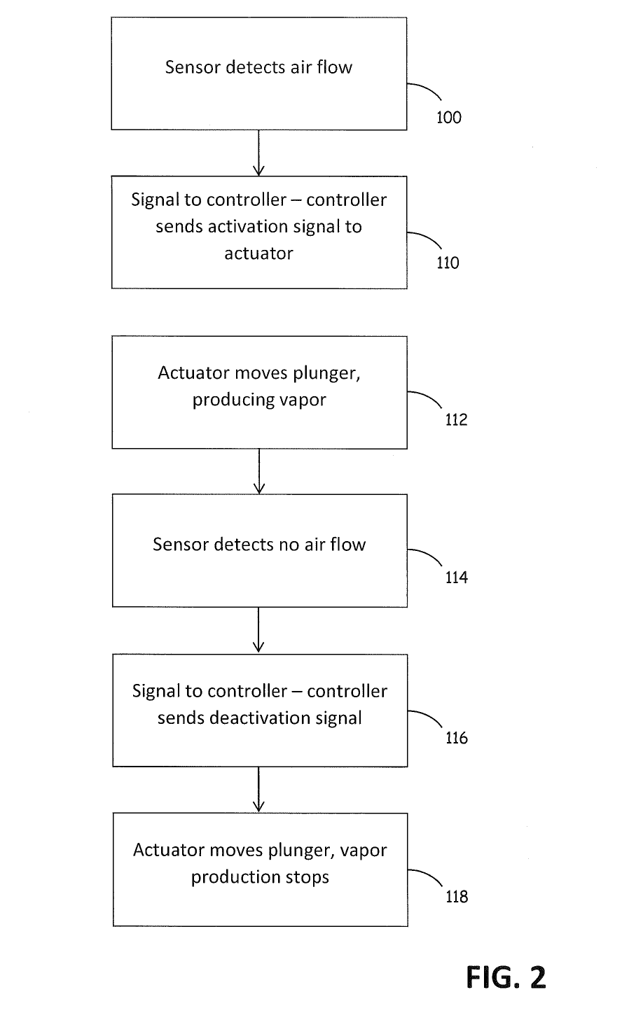

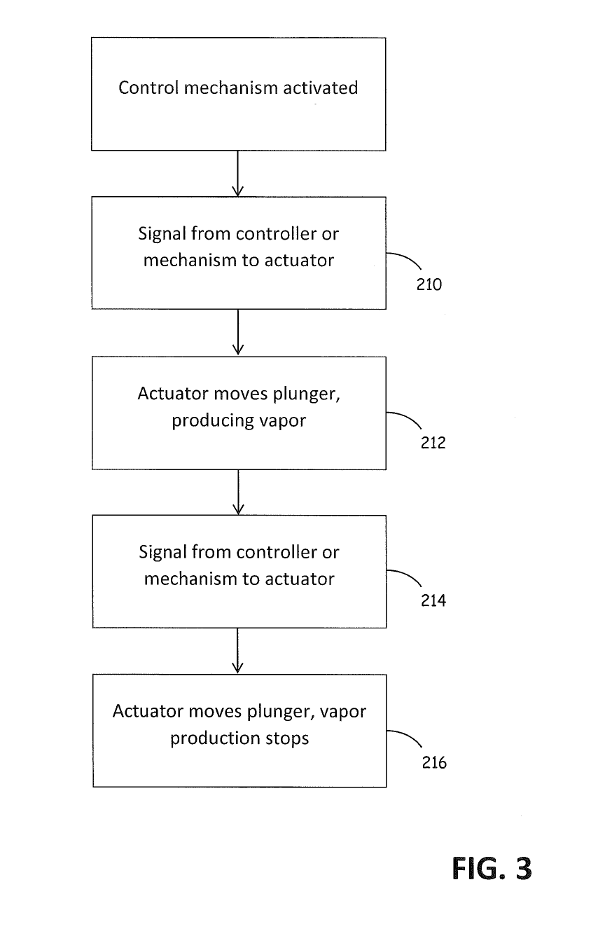

Referring to FIGS. 2-3, a method of using the actuator comprises providing 100 a sensor to detect air flow for sending 110 a signal to the controller which sends an activation signal to the actuator where the actuator moves 112, 212 the plunger which produces vapor. When the sensor detects no or decreased air flow 114 a signal is sent 116 to the control to deactivate the actuator and the actuator moves 118, 216 the plunger to release the push-hold button to cease vapor production. Similar, the signals for actuating and releasing the push—hold button may be manually sent 210, 214 from the controller.

Although the present disclosure has been described with reference to preferred embodiments, workers skilled in the art will recognize that changes may be made in form and detail without departing from the spirit and scope of the disclosure.

1. An actuator system comprising:
a housing;
a cavity configured to hold an e-cigarette comprises a push-hold button, the push button being configured to actuate a heating element of the e-cigarette for initiating vapor formation;
an automatic plunger configured for pressing the push-hold button upon receiving a command from a controller; and
a mechanism configured for positioning the automatic plunger proximate to the said push-hold button.

2. The actuator system of claim 1, and further comprising:
a sensor configured to sense the movement of air within the housing and to generate a signal indicative of air movement; and
wherein the controller is configured to actuate the automatic plunger to press the push-hold button upon receiving the signal indicative of air movement.

3. The actuator system of claim 1, wherein the plunger is configured for movement and wherein said movement is in the range of approximately 0.2 mm to 10 mm.

4. The actuator system of claim 1, and further comprising a mechanism configured to utilize a signal external to the device to actuate the plunger.

5. A method of actuating a device for vapor formation comprising:
providing a housing having a cavity configured to hold an e-cigarette comprising a push-hold button configured to actuate a heating element for vapor formation;
positioning the e-cigarette in the cavity;
providing an automatic plunger configured for pressing the push-hold button upon receiving a command from a controller; and
wherein the device further comprises a mechanism configured for positioning the automatic plunger proximate to the said push-hold button.

6. The method of claim 5, and further comprising:
generating a signal indicative of air movement by providing a sensor configured to sense the movement of air within the device;
transmitting the signal from the sensor to the controller; and
transmitting a signal to the automatic plunger and actuating the automatic plunger for generating vapor formation.

7. The method of claim 5, wherein the plunger is configured for movement and wherein said movement is in the range of approximately 0.2 mm to 10 mm.

8. The method of claim 5 and further comprising generating a signal external to the device and transmitting the signal to the controller for actuating the automatic plunger for generating vapor formation.

9. The method of claim 5 and generating vapor for a duration of a puff.
